(19) United States
(12) Patent Application Publication
(10) Pub. No.: US 2014/0105659 A1
(43) Pub. Date: Apr. 17, 2014

(54) HEATING BELT

(71) Applicant: CANON KABUSHIKI KAISHA, TOKYO (JP)

(72) Inventor: Yasuhiro Miyahara, Tokyo (JP)

(73) Assignee: CANON KABUSHIKI KAISHA, TOKYO (JP)

(21) Appl. No.: 14/044,059

(22) Filed: Oct. 2, 2013

(30) Foreign Application Priority Data
Oct. 16, 2012 (JP) 2012-228823

(51) Int. Cl. G03G 15/20

(52) U.S. Cl. CPC G03G 15/2053
USPC 399/333

(57) ABSTRACT

A heating belt has a sliding layer on an inner surface of a base member, the sliding layer composed of a polyimide resin layer formed by mixing a first polyimide precursor and a second polyimide precursor whose loss elastic modulus is greater than that of the first polyimide precursor. A high wear resistance and a high stick-slip inhibition effect can be retained for the sliding layer because the first polyimide precursor and the second polyimide precursor are mixed.

### BACKGROUND OF THE INVENTION

1. Field of the Invention

The present invention relates to a heating belt preferably used in a heating apparatus which heats a recording medium in an image forming apparatus such as a copier, a printer, a facsimile machine, or a multi-function printer, and more specifically to a configuration of the heating belt in which a sliding layer which slides against a slide member is formed on an inner circumferential surface of a base member of the heating belt.

2. Description of the Related Art

An image forming apparatus such as an electrophotographic or electrostatic recording image forming apparatus is provided with a fixing apparatus, i.e., a heating apparatus, which heats and presses a toner image formed on a recording medium to fix the toner image on the recording medium. Some fixing apparatus heats the image fixed on the recording medium again to adjust glossiness of the image. As such a fixing apparatus, in recent years, an on-demand type apparatus whose heat transfer efficiency is high and which starts up quickly is employed from the view point of promoting energy saving. As the on-demand type apparatus, there is proposed a belt heating type apparatus which heats the recording medium through an intermediary of a fixing belt, i.e., a heating belt, whose thermal capacity is low.

As the belt heating type apparatus, Japanese Patent Application Laid-Open Nos. S63-313182 and H2-157878 propose a structure in which a ceramic heater, i.e., a fixedly supported heating member, is frictionally slid against an inner circumferential surface of a fixing belt to heat a recording medium passing through a nip portion between the fixing belt and a pressure roller, i.e., a nip forming member. Such a structure, however, causes a frictional wear between the inner circumferential surface of the fixing belt and the ceramic heater. In order to avoid the problem of frictional wear, there is a case when a sliding layer is placed on an inner circumferential surface of the fixing belt. The sliding layer is required to be heat resistant, mechanically strong, and flexibile for the purpose of suppressing self-excited vibration, commonly called stick-slip.

However, not many materials which sufficiently satisfy these requirements exist, and even though a polyimide resin is often used, a higher performance is demanded and various improvements have been proposed. For example, in order to obtain a frictional sliding layer which excels in wear resistance, Japanese Patent Application Laid-Open No. 2004-012669 proposes a structure in which an imidization ratio of the polyimide resin of the sliding layer is set at 95% to 100%. Japanese Patent Application Laid-Open No. 2001-341231 proposes a structure in which the imidization ratio is set at 70% to 93%.

However, with the late demands on higher processing speed and on higher durability of the image forming apparatus, a further wear resistance is demanded on the sliding layer of the fixing belt that always slides against the slide member such as the ceramic heater. In addition, in order to suppress the stick-slip, the sliding layer is also required to be flexible.

The structure described in Japanese Patent Application Laid-Open No. 2004-012669 can assure sufficient wear resistance because a polyimide resin whose imidization ratio is 95% to 100% is used. However, because a loss elastic modulus of the polyimide resin is low, there is a possibility that it is unable to suppress vibration caused by the sliding friction and an abnormal sound (judder) is generated due to the stick-slip if lubricant between the sliding layer and the slide member is depleted.

Meanwhile, in the structure described in Japanese Patent Application Laid-Open No. 2001-341231, because the polyimide resin whose imidization ratio is 70% to 93% is used, the loss elastic modulus is high and the wear resistance is not sufficient, even though the stick-slip can be suppressed.

### SUMMARY OF THE INVENTION

According to one aspect of the present invention, there is provided an endless heating belt for heating an image on a recording medium, the heating belt including a base member made of a metal or a heat-resistant resin, and a sliding layer formed on an inner surface of the base member and sliding against a slide member, the sliding layer being a polyimide resin layer formed by mixing a first polyimide precursor and a second polyimide precursor whose loss elastic modulus is greater than that of the first polyimide precursor and by baking a mixture of the first and second polyimide precursors at a predetermined baking temperature.

Further features of the present invention will become apparent from the following description of exemplary embodiments with reference to the attached drawings. The accompanying drawings, which are incorporated in and constitute a part of the specification, illustrate exemplary embodiments, features, and aspects of the invention and, together with the description, serve to explain the principles of the invention.

### BRIEF DESCRIPTION OF THE DRAWINGS

FIG. 1 is a schematic structural cross sectional view of an image heating apparatus according to a preferred embodiment.

FIG. 2 is a schematic structural cross sectional view of a heating belt.

FIG. 3 is a schematic structural view of an apparatus configured to apply a polyimide resin layer.

FIG. 4 is a schematic structural view of an apparatus configured to form an elastic layer.

### DESCRIPTION OF THE EMBODIMENTS

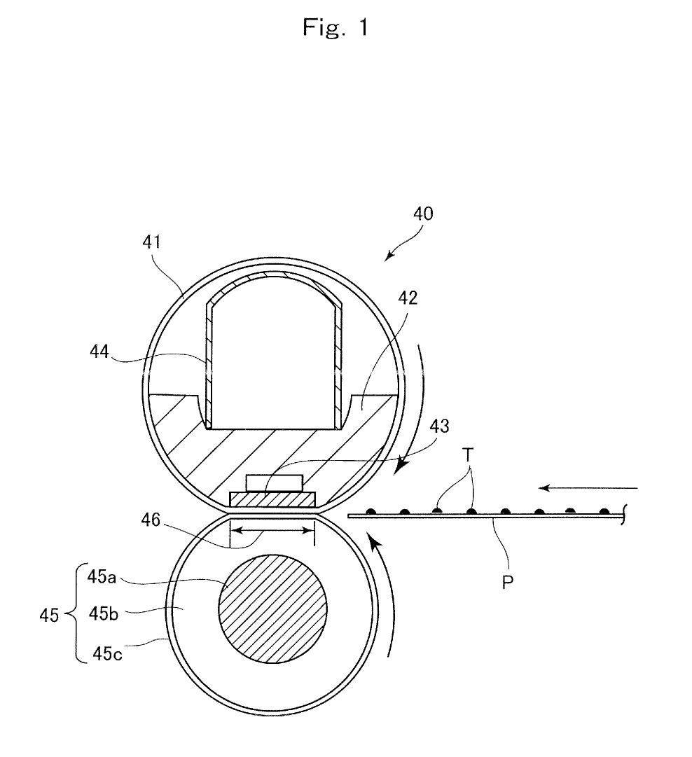

Preferred embodiments of the present invention will now be described with reference to FIGS. 1 through 4. Firstly, a fixing apparatus serving as a heating apparatus of the present embodiment will be described with reference to FIG. 1.

### [Fixing Apparatus]

A fixing apparatus 40 of the present embodiment is of a heater heating type using a ceramic heater 43 as a heating member. That is, the fixing apparatus 40 has a heating belt (fixing belt) 41 which is a heating member and which is an endless belt, a ceramic heater 43 serving as a heating body and a slide member, a belt guide member 42 serving as a slide member, and a pressure roller 45 serving as a nip portion forming member.

The ceramic heater 43 includes a resistive heating body formed by applying a conductive paste containing a silver-palladium alloy on a substrate of aluminum nitride by screen printing in the shape of a film having a uniform thickness. The ceramic heater 43 is fitted into a groove molded and provided along a longitudinal direction (width direction orthogonal to a recording medium conveying direction, a direction perpendicular to the surface of FIG. 1) of the belt guide member 42 and fixedly supported thereon. The ceramic heater 43 is electrically energized by a member not shown to generate heat and is controlled at a predetermined set temperature. The aluminum nitride substrate functions as the sliding layer (not shown) on a surface of the ceramic heater 43 in contact with the fixing belt 41.

As will be described below, the fixing belt 41 is an endless belt in which a sliding layer composed of a polyimide resin is formed on an inner circumferential surface (inner surface) of a base member composed of metal or heat-resistant resin, and the inner circumferential surface frictionally slides against the belt guide member 42 and the ceramic heater 43 in a state of use. A “belt” referred to in the present specification and in the claims also includes a film-like member. The fixing belt 41 rotates following to a rotation of the pressure roller 45 as described below. Accordingly, both ends of the fixing belt 41 in the rotation axis direction are in slidable contact with slidable-contact portions at ends of a support member and are rotatably supported by a stationary portion (not shown) such as a frame of the fixing apparatus 40.

The belt guide member 42, the ceramic heater 43, and the support member 44 are disposed inside of the fixing belt 41. The support member 44 is provided along a longitudinal direction of the fixing belt 41, and both ends thereof are supported by the stationary portion (not shown) such as the frame of the fixing apparatus 40. The belt guide member 42 is supported by the support member 44.

The belt guide member 42 is molded by a heat-resistant and heat-insulating resin, is provided along the support member 44 in the longitudinal direction of the fixing belt 41, and guides the rotation of the fixing belt 41 by sliding an outer circumferential surface thereof formed partially into a cylindrical surface against the inner circumferential surface of the fixing belt 41. In addition, the ceramic heater 43 is placed at a position of a part of the belt guide member 42 in contact with the inner circumferential surface of the fixing belt 41. The fixing belt 41 is loosely fitted around the belt guide member 42.

A semi-solid lubricant (not shown) composed of a solid component (compound) and a base oil component (oil) is applied on the inner circumferential surface of the fixing belt 41 to secure slidability between the ceramic heater 43 and the inner surface sliding layer of the fixing belt 41. Solid lubricants such as graphite and molybdenum disulfide, metal oxides such as zinc oxide and silica, fluororesins such as PFPE and PTFE are examples of the compound of the semi-solid lubricant. All of these materials are added to the grease as a powder having a particle size of about 3 μm. Heat resistant polymer resin oil such as silicone oil and fluorosilicone oil are examples of the base oil component. The present embodiment uses HP 300 (manufactured by Dow Corning Corporation) which employs PTFE powder particulates (having particle size of 3 μm) as the compound composing the grease and fluorosilicone oil as the oil.

The pressure roller 45 is composed of a stainless steel core 45a, an elastic layer 45b of silicone rubber formed on the core 45a, and a fluororesin tube surfacial layer 45c for improving releasability. Both ends of the core 45a are rotatably supported by the stationary portion (not shown). Such a pressure roller 45 is linked with a rotational driving apparatus (not shown) such as a motor and is rotationally driven during operation.

A pressure spring (not shown) is compressively provided between both ends of the support member 44 and spring receiving members (not shown) on the frame side of the apparatus to apply a force to the support member 44 so that the support member 44 is biased toward the pressure roller 45. Thereby, a nip portion 46 where the recording medium passing between the pressure roller 45 and the fixing belt 41 is heated is formed.

The pressure roller 45 is linked with the rotational driving apparatus (not shown), so that the recording medium is nipped and conveyed in the nip portion by the fixing belt 41 that rotates following to the pressure roller 45. The ceramic heater 43 heats a surface of the fixing belt 41 to a predetermined temperature, e.g., 200° C. A thermistor (not shown) serving as a temperature detecting sensor and provided on the surface of the fixing belt 41 detects the predetermined temperature, and the temperature is adjusted by controlling the energization applied to the ceramic heater 43 by a controller (not shown). The recording medium P on which an image is formed by a unfixed toner (t) and which is to be heated is nipped and conveyed by the nip portion 46 in the state in which the temperature of the surface of the fixing belt 41 is adjusted to the predetermined temperature. Thus, the toner image is fixed on the recording medium through the processes of heating the recording medium P in contact with the outer circumferential surface of the fixing belt 41 to heat, press, melt and blend the toner image on the recording medium P, and of then cooling the toner image.

### [Fixing Belt]

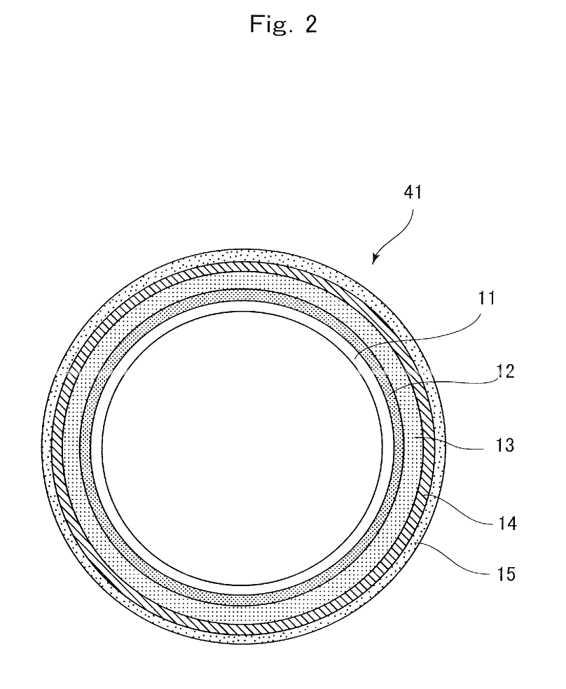

The fixing belt 41 of the present embodiment will now be described with reference to FIGS. 2 through 4. As shown in FIG. 2, the fixing belt 41 is an endless belt formed by layering, from the inside, a sliding layer 11, a base member 12, an elastic layer 13, an adhesive layer 14, and a surfacial layer 15.

### [Base Member]

A metal or a heat-resistant resin is preferably used for the base member 12 in consideration of the heat resistance and bending resistance because a high heat resistance is required for the fixing belt 41. For example, a nickel electroforming cylindrical base member disclosed in Japanese Patent Application Laid-Open No. 2002-248648, International Publication No. 05/54960, and Japanese Patent Application Laid-Open No. 2005-121825 may be adopted as the metal base member. A specific example would be what sulfur, phosphorus, carbon, or the like is added to a nickel-iron alloy whose mass ratio is 90% or greater.

A polyimide resin, a polyamide-imide resin, a polyether-ether-ketone resin, or the like disclosed in Japanese Patent Application Laid-Open Nos. 2005-300915 and No. 2010-134094 may be employed as the heat-resistant resin base member. In the present embodiment, an endless metal cylindrical base member made of the nickel-iron alloy of φ30 mm in inner diameter, 40 μm in thickness, and 400 mm in length as disclosed in International Publication No. 05/54960 is employed.

### [Elastic Layer]

The elastic layer 13 is a silicone rubber layer covering an outer circumferential surface of the base member 12. Such an elastic layer 13 functions to surround the toner without a gap when the toner is fixed on the recording medium passing through the nip portion. While the elastic layer 13 is not particularly limited so long as such a function is achieved, it is preferable to use what an addition-cure type silicone rubber is cured in view of the processability. It is because such an arrangement allows adjustment of elasticity by adjusting a degree of cross-linkage according to a type and an additive amount of a filler to be described later.

In general, an addition-cure type silicon rubber contains organopolysiloxane having an unsaturated aliphatic group, organopolysiloxane having active hydrogen bonded to silicon, and a platinum compound serving as a cross-linkage catalyst. The organopolysiloxane having active hydrogen bonded to silicon forms a cross-linkage structure by a reaction with an alkenyl group of the organopolysiloxane component having the unsaturated aliphatic group, through a catalytic action of the platinum compound.

The elastic layer 13 may further contain a filler for improvement of thermal conductivity, reinforcement, improvement of heat resistance, or the like, of the fixing member. In particular, for the purpose of improvement of the thermal conductivity, the filler is preferable to have a high thermal conductivity. Specifically, an inorganic substance, in particular, a metal or a metal compound may be employed.

Silicon carbide (SiC), silicon nitride (Si₃N₄), boron nitride (BN), aluminum nitride (AlN), alumina (Al₂O₃), zinc oxide (ZnO), and magnesium oxide (MgO) may be listed as specific examples of the high heat conductive filler. Alternatively, silica (SiO₂), copper (Cu), aluminum (Al), silver (Ag), iron (Fe), nickel (Ni), or the like may be also listed.

These materials may be used as a single entity or as a combination of two or more of these materials. The highly heat-conductive filler preferably has an average particle size of greater than or equal to 1 μm and less than or equal to 50 μm in view of handling and dispersion properties. While the shape of the filler employed may be globular, crushed, needle-like, plate-like, a whiskered, or the like, it is preferable to be globular from the viewpoint of dispersion properties.

A preferable range of the thickness of the silicone rubber layer is greater than or equal to 100 μm and less than or equal to 500 μm, and a more preferable range is greater than or equal to 200 μm and less than or equal to 400 μm, from the view point of contribution to the surface hardness of the fixing belt 41 and of the efficiency of thermal conductivity to the unfixed tonner during the fixing process.

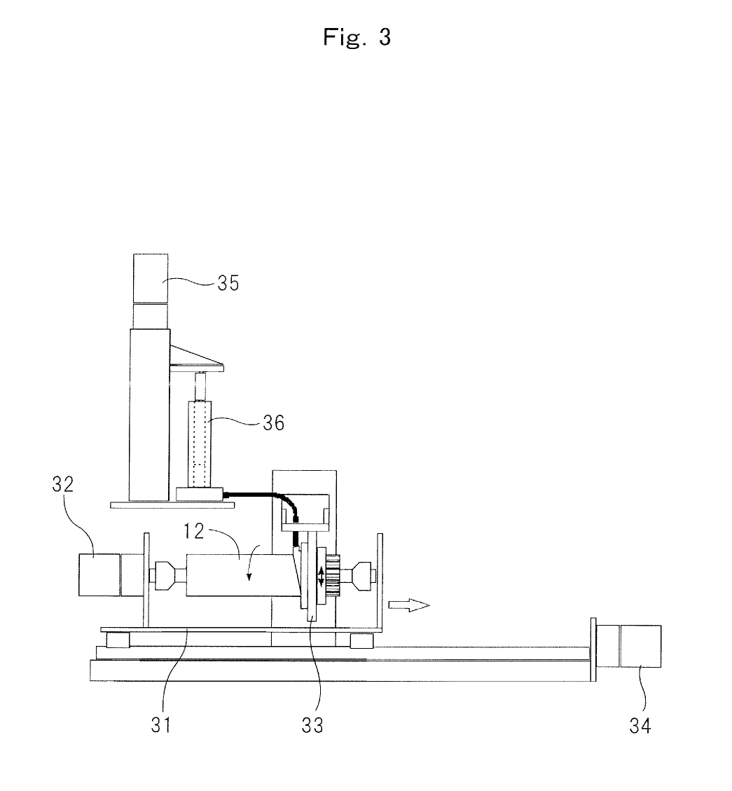

Formation of the elastic layer 13 as described above will now be described with reference to FIG. 3. FIG. 3 is a schematic diagram illustrating one exemplary process for forming the elastic layer 13 on the base member 12 and explaining a method known as ring coating. The base member 12 which is rotationally driven by a motor 32 is retained on a retaining structure 31. An addition-cure type silicone rubber composition in which the addition-cure type silicone rubber and the filler are mixed is filled into and pumped by a cylinder pump 36 which is driven by a motor 35. The addition-cure type silicone rubber composition is applied from an coating liquid supply nozzle (not shown) placed within a coating head 33 to a circumferential surface of the base member 12. The base member 12 is fitted around and fixed to the cylindrical core which is inserted therein and is connected to and driven by the motor 32.

In the same time with the application, the base member 12 is moved in a right direction of FIG. 3 with a constant speed by driving a motor 34 that moves the retaining structure 31 in the horizontal direction in FIG. 3 to form an coating film of the addition-cure type silicone rubber composition on the circumferential surface of the base member 12. A thickness of the coating film can be controlled by a clearance between the coating liquid supply nozzle and the base member 12, supply speed of the silicone rubber composition, the moving velocity of the base member 12, or the like. The addition-cure type silicone rubber composition layer formed on the base member 12 is heated for a certain time period by a heating apparatus such as an electric furnace to promote the cross-linking reaction. Thereby the silicone rubber elastic layer 13 as described above can be formed.

### [Surfacial Layer]

The surfacial layer 15 is a fluororesin layer. A copolymer of tetrafluoroethylene-perfluoro (alkylvinyl ether) (PFA), polytetrafluoroethylene (PTFE), a copolymer of tetrafluoroethylene-hexafluoropropylene (FEP), or the like are examples of the fluororesin. The surfacial layer 15 is formed by molding such a resin into a shape of a tube. A material, a thickness, a covering method, or the like can be selected in consideration of moldability, toner releasability, surface hardness as the fixing belt, or the like. The surfacial layer 15 makes it more difficult for the toner to attach on the fixing belt 41. The surfacial layer 15 is placed over the elastic layer 13 with the adhesive layer 14 composed of silicone therebetween.

Among the exemplary materials listed above, PFA is preferably employed for the surfacial layer 15 in view of the moldability and the toner releasability. In addition, the thickness is preferably less than or equal to 50 μm because this thickness allows the elasticity of the silicone rubber layer which is an underlaid layer to be maintained and to suppress the surface hardness from increasing too much as the fixing member. Furthermore, it is possible to improve adhesiveness of the inner surface of the fluororesin tube, i.e., the surfacial layer 15, by applying a sodium process, an excimer laser process, an ammonia process, or the like in advance.

The surfacial layer 15 is formed in the following manner. An addition-cure type silicone rubber adhesive (adhesive layer 14) is applied on the surface of the elastic layer 13 described above. Then, the outer surface of this structure is covered by the surfacial layer 15 i.e., the fluororesin layer. While the covering method is not particularly limited, it is possible to use such a covering method of the outer surface by using the addition-cure type silicon rubber adhesive as a lubricating member or of expanding the fluororesin tube from the outside and covering the outer surface.

A redundant addition-cure type silicone rubber adhesive remaining between the curing silicone rubber layer and the fluororesin layer is then removed by squeezing by using an apparatus (not shown). The thickness of the adhesive layer after squeezing the redundant adhesive is preferably less than or equal to 20 μm.

Here, the adhesive layer 14 fixing the surfacial layer 15 on the elastic layer 13 is composed of the cured material of the addition-cure type silicone rubber adhesive applied on the surface of the elastic layer 13. The addition-cure type silicone rubber adhesive includes addition-cure type silicone rubber in which a self-adhesive component is mixed typified by silane having a functional group such as an acryloxy group, a hydrosilyl group (SiH group), an epoxy group, and an alkoxysilyl group. The addition-cure type silicone rubber adhesive can be cured and adhesive by heating for a predetermined time period by a heating apparatus such as an electric furnace. Because the sliding layer 11, the detail of which will be described below, has been already formed on the inner side of the base member 12 in the belt structure to which the surfacial layer 15 is adhered, so that the above-described fixing belt 41 can be obtained by cutting both ends of the belt structure on which the surfacial layer 15 is adhered in a desired length.

### [Sliding Layer]

The sliding layer 11 is a polyimide resin layer. For example, the sliding layer 11 is formed by obtaining a polyimide precursor solution by a reaction between aromatic tetracarboxylic dianhydride or a derivative thereof and approximately equi-molar aromatic diamine in an organic polar solvent, by applying, drying, and heating the polyimide precursor solution on the inner circumferential surface of the base member 12, and by causing a dehydration ring-closure reaction.

This polyimide resin layer is formed of a mixture of a first polyimide precursor and a second polyimide precursor whose loss elastic modulus is greater than that of the first polyimide precursor. An imidization ratio of the first polyimide precursor is 95% to 100% with a predetermined baking temperature, e.g., 250° C., and an imidization ratio of the second polyimide precursor is 70% to 93% with the predetermined baking temperature, e.g., 250° C. The polyimide resin layer is formed by the mixture of the first polyimide precursor and the second polyimide precursor baked under the predetermined baking temperature condition.

In the present embodiment, a mass mixture ratio of the first polyimide precursor and the second polyimide precursor is set in a range of (first polyimide precursor): (second polyimide precursor)=1:9 to 4:6. In addition, a glass transition point Tg2 of the second polyimide precursor, i.e., a glass transition point of a polyimide obtained by baking the second polyimide precursor at the predetermined baking temperature, is approximately equal to the predetermined temperature T which is a temperature control temperature of the fixing belt 41 described above. The glass transition point Tg2 is in a range of greater than or equal to T−20° C. and less than or equal to T+20° C. A glass transition point Tg1 of the first polyimide precursor, i.e., a glass transition point of a polyimide obtained by baking the first polyimide precursor at the predetermined baking temperature, is higher than the glass transition point Tg2 of the second polyimide precursor.

In a viscoelastic substance such as the polyimide, a storage elastic modulus (E′) is reduced and the loss elastic modulus (E″) is increased in a temperature range exceeding the glass transition point. In general, it is known that the glass transition point (Tg) increases when the imidization ratio increases. For example, a glass transition point Tg1 of polyimide prepared by using U-Varnish-S (manufactured by Ube Industries, Ltd.) as the precursor and by adjusting the imidization ratio to 95% to 100% is 359° C. Meanwhile, the glass transition point Tg2 of the polyimide prepared so that the imidization ratio is 70% to 93% is 210° C.

The glass transition point Tg1 of the polyimide prepared in the state in which the imidization ratio is 95% to 100% has a relatively higher value as compared to the surface temperature (predetermined temperature) of the fixing belt of the fixing apparatus when the image forming apparatus is in operation. Due to that, when the sliding layer is formed of the first polyimide, the sliding layer does not reach the glass transition point at the temperature under the actual usage condition of the fixing apparatus. Therefore, although the sliding layer formed of the first polyimide is rich in wear resistance because it maintains the state in which the high storage elastic modulus is high and it is rigid, it reduces the effect of suppressing the self-excited vibration such as the stick-slip because its loss elastic modulus is low.

Meanwhile, the glass transition point Tg2 of the polyimide prepared in the state when the imidization ratio is 70% to 93% is a temperature near the above-described predetermined temperature so that when the sliding layer is formed of the second polyimide, the sliding layer is in a temperature range near the glass transition point under the actual usage condition. Thus, although the sliding layer formed of the second polyimide is in a state in which the storage elastic modulus is low and the wear resistance is low. However, the effect of suppressing the stick-slip increases because the loss elastic modulus is high.

Therefore, the first and second polyimide precursors become compatible from each other by mixing them in the solution state as the sliding layer 11, and, as a result, it becomes possible to maintain the high wear resistant and high stick-slip suppressing effects as the whole layer. Of the occurrence of the stick-slip and the exposure of the base member caused by scraping of the sliding layer 11, the stick-slip occurs often at an earlier stage and often becomes a lifetime-determining factor. Due to that, the mass mixture ratio of the second polyimide precursor may be increased more than that of the first polyimide precursor to prolong a lifetime of the fixing belt and the fixing apparatus as a whole.

It is noted that the polyimide resin layer described above preferably contains an inorganic filler such as molybdenum disulfide. By containing such an inorganic filler, the surface of the sliding layer 11 is roughened, and a contact area with the slide member such as the ceramic heater 43 can be reduced. The inorganic filler also functions as a solid lubricant. As a result, it is possible to improve the wear resistance and to suppress the stick-slip further. The sliding layer 11 preferably has a ten-point average roughness of the surface of 2.5 μm to 6.5 μm. Such a configuration enables the contact area with the slide member to be reduced and the lubricant applied on the surface of the sliding layer 11 to be more readily kept, so that the stick-slip can be suppressed further.

Next, the polyimide resin as described above will be described in detail. The first and second polyimide precursors are preferably aromatic polyimide precursors, respectively. To that end, each of the polyimide precursors is composed of, for example, aromatic tetracarboxylic acid and aromatic diamine.

Typical examples of the aromatic tetracarboxylic acid include: pyromellitic dianhydride; 3,3′,4,4′-biphenyl tetracarboxylic dianhydride; 3,3′,4,4′-benzophenone tetracarboxylic dianhydride; and 2,3,6,7-naphthalene tetracarboxylic dianhydride. These aromatic tetracarboxylic acids may be used as a single entity or as a combination of two or more materials.

### [First Polyimide Precursor]

A polyimide having a structure having a high imidization ratio even with a low baking temperature is suitable as the first polyimide precursor. For such a polyimide resin, it is effective to place an ether bond or a carbonyl bond between benzene rings of aromatic diamine in order to give fluidity and to reduce the concentration of the imide group. In the present embodiment, a polyimide precursor solution composed of 3,3′,4,4′-biphenyl tetracarboxylic dianhydride as the aromatic tetracarboxylic acid and 4,4′-diaminodiphenyl ether as the aromatic diamine is employed as the first polyimide precursor. When the polyimide precursor having such a structure is baked at 250° C., the imidization ratio would be 95% to 100%.

### [Second Polyimide Precursor]

The imidization ratio is desirably retained low at a low baking temperature as the second polyimide precursor. A polyimide resin having high crystallinity and high concentration of imide group is suitable as such a polyimide resin, so that a number of aliphatic C—H groups and others between the benzene rings of the aromatic diamine is preferable to be as less as possible. In the present embodiment, a polyimide precursor solution composed of 3,3′,4,4′-biphenyl tetracarboxylic dianhydride as the aromatic tetracarboxylic acid described above and paraphenylenediamine or benzidine as the aromatic diamine is employed as the second polyimide precursor. When the polyimide precursor having such a structure is baked at 250° C., the imidization ratio would be 70% to 93%. These aromatic diamines may be used as a single entity or as a combination of two or more materials.

### [Polyimide Precursor Solution]

In order to be able to apply the polyimide resin formed by mixing the first and second polyimide precursors on the inner circumferential surface of the base member 12, the first and second polyimide precursors are caused to react in an organic polar solvent to form a polyimide precursor solution. Dimethyl acetamide, dimethylformamide, N-methyl-2-pyrrolidone, phenol, O-, M-, P-cresol, or the like may be cited as the organic polar solvent. In the present embodiment, a solution obtained by mixing N-methyl-2-pyrrolidone solution as the first polyimide precursor with N-methyl-2-pyrrolidone solution as the second polyimide precursor using paraphenylene diamine as the aromatic diamine at a certain ratio is employed as the polyimide precursor solution. The former is available as U-Varnish-A (manufactured by Ube Industries Ltd.), and the latter is available as U-Varnish-S (manufactured by Ube Industries Ltd.).

As described above, the mass mixture ratio of the first and second polyimide precursors in the polyimide resin layer is desirably between 1:9 to 4:6. The ratios in this range allow the wear resistant and stick-slip suppressing effects to be fully assured. In the present embodiment, a blend ratio of the U-Varnish-A with the U-Varnish-S is adjusted so that the ratio falls under the above-described range.

Moreover, as described above, the polyimide resin layer may contain the inorganic filler to achieve higher thermal conductivity or higher wear resistance. As the inorganic filler, silicon carbide (SiC), silicon nitride (Si₃N₄), boron nitride (BN), aluminum nitride (AlN), alumina (Al₂O₃), zinc oxide (ZnO), magnesium oxide (MgO), and silica (SiO₂) may be cited. Molybdenum disulfide (MoS₂), graphite, titanium nitride (TiN), mica, and synthesized mica may be also cited.

### [Formation of Sliding Layer]

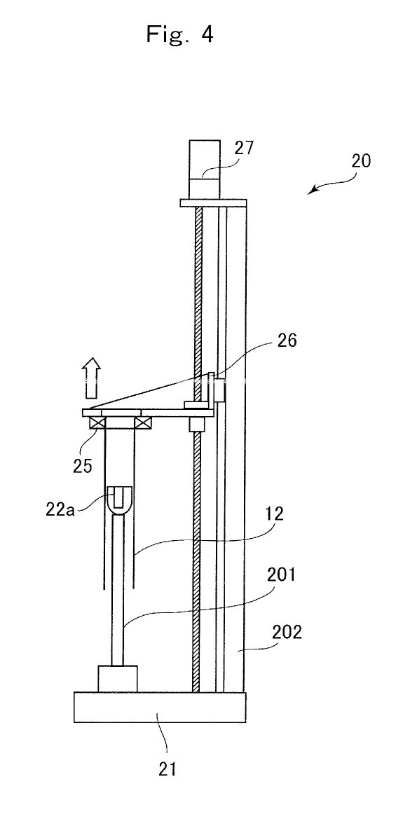

Next, a method for forming the above-described sliding layer 11 formed of the polyimide resin will be described with reference to FIG. 4. In general, the method for forming the polyimide resin layer is known to form the polyimide precursor solution as described above through casting or the like. The above-described polyimide precursor solution is applied on the inner circumferential surface of the base member 12 and is then dried and heated to form the polyimide resin sliding layer by the dehydration ring-closure reaction also in the present embodiment.

Known methods such as dipping and ring coating may be employed as the coating method. In the present embodiment, the ring coating method as described below is employed. A ring coating apparatus 20 as shown in FIG. 4 is provided with columns 201 and 202 disposed in parallel to each other on a base 21. A coating head 22a is fixed on the column 201 and is connected with a coating liquid supply apparatus (not shown). The coating head 22a is formed into a columnar shape and is provided with a supply path from the coating liquid supply apparatus placed at a center portion thereof and with a plurality of slits formed in parallel with the column 201 on an outer circumferential surface thereof. A plurality of branch paths is formed radially from the supply path toward the plurality of slits. Therefore, the coating liquid (polyimide precursor solution) supplied from the coating liquid supply apparatus is discharged out of the slits to coat the outer circumferential surface of the coating head 22a.

A work moving apparatus 26 is supported by the column 202 movably along the column 202. The work moving apparatus 26 moves up and down in FIG. 4 along the column 202 by a rotational driving force of a motor 27 provided on the column 202. The work moving apparatus 26 is provided with a work hand 25 placed at a front end thereof and configured to retain the base member 12. Therefore, the base member 12 retained by the work hand 25 moves up and down in FIG. 4 together with the work hand 25 by the work moving apparatus 26.

In order to apply the coating liquid on the inner circumferential surface of the base member 12, the base member 12 is moved along the outer periphery of the coating head 22a while supplying the polyimide precursor solution, i.e., the coating liquid, from the coating liquid supply apparatus to the outer periphery of the coating head 22a. This process makes it possible to apply the coating liquid substantially uniformly over the entirety of the inner circumferential surface of the base member 12. This apparatus makes it possible to determine a thickness of the coating liquid by a coating amount and to obtain an arbitrary amount of coating by changing a supply rate of the coating liquid and moving speed of the work moving apparatus 26.

The polyimide resin sliding layer 11 can be formed by heating the polyimide precursor solution thus formed on the inner surface of the base member 12 for a certain period of time by a heating apparatus such as an electric furnace to promote the cross-linkage reaction. For the reasons described above, the baking temperature at this time must be set at the temperature by which the imidization ratio of the first polyimide resin becomes 95% to 100% and the imidization ratio of the second polyimide resin becomes 70% to 93%.

If a roughening process is applied on the surface of the sliding layer 11 after forming the sliding layer 11, the area of contact between the sliding layer 11 of the inner surface of the fixing belt 41 and the ceramic heater 43 is reduced and the lubricant tends to more easily stay in recess portions, so that it may be possible to prolong the lifetime. As described above, the ten-point average roughness of the surface of the sliding layer 11 at this time is desirable to be 2.5 μm to 6.5 μm.

The above-described imidization ratio refers to a ratio between a number of imide rings produced by the reaction and a number of imide rings after when the reaction is completely finished. In the present embodiment, the imidization ratio was measured in the following manner. Firstly, a FTIR/ATR (Fourier-Transform Infrared Absorption Spectrometry/Attenuated Total Reflection) measurement is performed on the surface of the resin layer. Then, a ratio of a light absorbance of a peak around 1773 cm⁻¹ based on the C═O vibration of the imide ring and a light absorbance of a peak around 1366 cm⁻¹ based on the C—N contraction vibration of the imide group is determined. The imidization ratio is then determined by assuming that the imidization ratio when the same polyimide resin is baked at 400° C. is 100%. These processes can be summarized by the following equations:

Imidization ratio[%]=(a/b)/(A/B)×100

where (a) is the light absorbance of the peak around 1773 cm⁻¹;

(b) is the light absorbance of the peak around 1366 cm⁻¹;

(A) is the light absorbance of the peak around 1773 cm⁻¹ when baked at 400° C.; and

(B) is the light absorbance of the peak around 1366 cm⁻¹ when baked at 400° C.

As described above, because the first polyimide precursor and the second polyimide precursor are characterized in the structure of the aromatic diamine, it is possible to estimate the mass mixture ratio of the first and second polyimide precursors based on the different portions thereof. For example, when the U-Varnish-A is employed as the first polyimide precursor and the U-Varnish-S is employed as the second polyimide precursor as the present embodiment, the mass mixture ratio can be determined in the following manner. That is, it is possible to confirm that the peak derived from the skeleton structure of the benzene ring is divided into two peaks of 1499 cm⁻¹ and 1516 cm⁻¹ due to the difference of existence of the adjacent ether bond and to determine the mass mixture ratio based on the ratio of these two peaks.

(mass of first polyimide precursor):(mass of second polyimide precursor)=(c/C):(d/D)

where (c) is the light absorbance of the peak of benzene ring derived from the first polyimide precursor (1499 cm⁻¹ in the present embodiment);

(d) is the light absorbance of the peak of benzene ring derived from the second polyimide precursor (1516 cm⁻¹ in the present embodiment);

(C) is the light absorbance of the peak of the wave number of (c) of a polyimide resin layer formed of only the first polyimide precursor; and

(D) is the light absorbance of the peak of the wave number of (d) of a polyimide resin layer formed of only the second polyimide precursor.

In the present embodiment, as described, the sliding layer 11 is the polyimide resin layer formed by mixing the first polyimide precursor and the second polyimide precursor whose loss elastic modulus is greater than that of the first polyimide precursor. Due to that, it is possible to realize the structure with excellent flexibility and high wear resistance. In particular, because the imidization ratio of each of the polyimide precursors is defined as described above, the loss elastic modulus of the sliding layer 11 as a whole increases and the stick-slip suppressing effect acts by mixing the first polyimide precursor with the second polyimide precursor. In addition, because the flexibility is increased, a mechanical stress applied on the base member 12 is also reduced. Furthermore, because the first polyimide precursor whose loss elastic modulus is low is mixed, the wear resistance can be increased. As a result, endurance of the overall fixing belt 41 is improved.

### [Confirmation of Advantageous Efffects]

Various tests and evaluations performed to confirm advantageous effects of the present embodiment and results thereof will be described below with reference to the first through third examples. Firstly, TABLE 1 shows the structure of the sliding layer 11 of the fixing belt of each sample of the respective examples and comparative cases, and results of the respective tests and evaluations. It is noted that TABLE 1 shows the mass mixture ratio between the first and second polyimide precursors, the baking temperature of the polyimide precursor, existence of the inorganic filler, and the ten-point average roughness Rz (μm) of the surface of the sliding layer 11 of each sample.

TABLE 1

| | (1)FIXING BELT | | | | (2)EVALUATION |
|---|---|---|---|---|---|
| | MASS MIXTURE RATIO | | | | OF WEAR |
| | OF FIRST POLYIMIDE | | | | RESISTANCE |
| | PRECURSOR:SECOND | BAKING | | | SCRATCH |
| SAMPLE NAME | POLYIMIDE PRECURSOR | TEMPERATURE | FILLER | Rz (μm) | HARDNESS |
| A | 10:0 | 250° C. | — | 1.0 | 1400 g |
| B | 7:3 | 250° C. | — | 1.1 | 1500 g |
| C | 6:4 | 250° C. | — | 1.1 | 1700 g |
| EXAMPLE 1-1 | 4:6 | 250° C. | — | 1.0 | 2100 g |
| EXAMPLE 1-2 | 1:9 | 250° C. | — | 0.9 | 1800 g |
| D | 0:10 | 300° C. | — | 1.0 | 1100 g |
| E | 10:0 | 300° C. | — | 1.0 | 1500 g |
| F | 7:3 | 300° C. | — | 1.1 | 1600 g |
| G | 6:4 | 300° C. | — | 0.9 | 1900 g |
| H | 4:6 | 300° C. | — | 0.9 | 2300 g |
| I | 1:9 | 300° C. | — | 1.0 | 2000 g |
| J | 0:10 | 300° C. | — | 1.0 | 1300 g |
| K | 10:0 | 250° C. | MoS2 | 4.5 | 1600 g |
| L | 7:3 | 250° C. | MoS2 | 4.3 | 1700 g |
| M | 6:4 | 250° C. | MoS2 | 4.5 | 1900 g |
| EXAMPLE 2-1 | 4:6 | 250° C. | MoS2 | 4.4 | 2300 g |
| EXAMPLE 2-2 | 1:9 | 250° C. | MoS2 | 4.5 | 2000 g |
| N | 0:10 | 250° C. | MoS2 | 4.5 | 1200 g |
| O | 10:0 | 250° C. | — | 4.3 | 1400 g |
| P | 7:3 | 250° C. | — | 4.5 | 1600 g |
| Q | 6:4 | 250° C. | — | 4.4 | 1700 g |
| EXAMPLE 3-1 | 4:6 | 250° C. | — | 4.5 | 2100 g |
| EXAMPLE 3-2 | 1:9 | 250° C. | — | 4.4 | 1800 g |
| R | 0:10 | 250° C. | — | 4.5 | 1100 g |

| | | (4)SHEET FEEDING ENDURANCE | | |
|---|---|---|---|---|
| | | TEST OF ACTUAL MACHINE | | |
| | | | NUMBER OF | |
| | (3)IDLING | NUMBER OF | SHEETS FED | |
| | ACCELERATION | SHEETS FED | UNTIL WHEN | |
| | ENDURANCE TEST | UNTIL WHEN | BASE MEMBER IS | |
| | STICK-SLIP | STICK-SLIP | EXPOSED DUE TO | |
| | (JUDDER) | (JUDDER) | CRACKING OF | |
| SAMPLE NAME | OCCURRING TIME | OCCURS | INNER SURFACE | OTHERS |
| A | 70 min | 50k | — | — |
| B | 100 min | 70k | — | — |
| C | 150 min | 150k | — | — |
| EXAMPLE 1-1 | GREATER | GREATER | — | — |
| | THAN 400 min | THAN 300k | | |
| EXAMPLE 1-2 | GREATER | GREATER | — | — |
| | THAN 400 min | THAN 300k | | |
| D | GREATER | — | 220K | — |
| | THAN 400 min | | | |
| E | 50 min | 52k | — | — |
| F | 150 min | 60k | — | — |
| G | 200 min | 140k | — | — |
| H | 300 min | 190k | — | — |
| I | 350 min | — | — | BASE MEMBER |
| | | | | CRACKED AFTER |
| | | | | 250k SHEETS |
| J | GREATER | — | — | BASE MEMBER |
| | THAN 400 min | | | CRACKED AFTER |
| | | | | 250k SHEETS |
| K | 160 min | 100k | — | — |
| L | 170 min | 195k | — | — |
| M | 220 min | GREATER | — | — |
| | | THAN 270k | | |
| EXAMPLE 2-1 | GREATER | GREATER | — | — |
| | THAN 400 min | THAN 300k | | |
| EXAMPLE 2-2 | GREATER | GREATER | — | — |
| | THAN 400 min | THAN 300k | | |
| N | GREATER | GREATER | — | — |
| | THAN 400 min | THAN 300k | | |
| O | 140 min | 90k | — | — |
| P | 150 min | 170k | — | — |
| Q | 200 min | GREATER | — | — |
| | | THAN 240k | | |
| EXAMPLE 3-1 | GREATER | GREATER | — | — |
| | THAN 400 min | THAN 300k | | |
| EXAMPLE 3-2 | GREATER | GREATER | — | — |
| | THAN 400 min | THAN 300k | | |
| R | GREATER | GREATER | — | — |
| | THAN 400 min | THAN 300k | | |

### First Example

In the first example, the fixing belt 41 was formed in the following manner. Specifically, the sliding layer 11 of the polyimide resin shown in TABLE 1 was formed to be 15 μm in thickness on the inner circumferential surface of the base member 12 made of a nickel-iron alloy of φ30 mm in inner diameter, 40 μm in thickness and 400 mm in length. Further, the silicone rubber elastic layer 13 of 300 μm in thickness was layered on the outer circumferential surface of the base member 12 and the outer surfacial layer 15 made of the PFA tube and having a thickness of 40 μm was layered on the elastic layer 13 with the silicone adhesive layer 14 having a thickness of 5 μm therebetween. Thus, the fixing belt 41 is formed.

The U-Varnish-A (manufactured by Ube Industries, Ltd.) was employed as the first polyimide precursor and the U-Varnish-S (manufactured by Ube Industries, Ltd.) was employed as the second polyimide precursor. The U-Varnish-A is the polyimide precursor solution which uses pyromellitic dianhydride as the aromatic tetracarboxylic acid and 4,4′-diaminodiphenyl ether as the aromatic diamine. The U-Varnish-S is the polyimide precursor solution which uses pyromellitic dianhydride as the aromatic tetracarboxylic acid and paraphenylene diamine.

The baking temperature in forming the sliding layer 11 was set at 250° C. or 300° C. Here, the baking temperature of 250° C. is a temperature condition that leads to 100% of the imidization ratio of the first polyimide precursor and 88% of the imidization ratio of the second polyimide precursor. Meanwhile, the baking temperature of 300° C. is a baking temperature condition that leads to 100% of the imidization ratio of the first polyimide precursor and 97% of the imidization ratio of the second polyimide precursor.

A loss elastic modulus of the first polyimide precursor baked at 250° C. was 1.0×10⁷ Pa (at a measurement temperature of 200° C., which was the usage temperature in forming an image), and a loss elastic modulus of the second polyimide precursor was 3.7×10⁷ Pa (at 200° C.). Moreover, a loss elastic modulus of the first polyimide precursor baked at 300° C. was 1.0×10⁷ Pa (at 200° C.), and a loss elastic modulus of the second polyimide precursor was 1.9×10⁷ Pa (at 200° C.). TABLE 1 shows samples of the fixing belts having the sliding layers thus produced. The following evaluations of wear resistance and various endurance tests were carried out on Examples 1-1 and 1-2 and Samples A to J in TABLE 1 in the first example.

### [Evaluation of Wear Resistance]

The wear resistance of the sliding layer of an actual machine is related to scratch hardness of the sliding layer. A sliding layer with a low scratch hardness has a higher wear speed, so that a load torque increasing speed caused by wear powder is fast and a sheet conveyance failure occurs at an earlier stage in the actual machine.

The scratch hardness of each sliding layer was evaluated by using a part of the inner circumferential surface of the fixing belt of each sample as a sample polished portion and by evaluating the wear resistance of each resin layer by using a linear reciprocating sliding tester (friction player FRP-2100 manufactured by Rhesca Corporation). A scraped condition of the surface of the sliding layer was observed after pressing an alumina ball having φ 3/16 inches as a contact to the surface of the sliding layer under an environment at 200° C. and reciprocating the contact with a speed of 200 mm/sec within a width of 30 mm by 300 times. The load was increased in units of 50 g, and a load by which the scrape reaches the base member was determined as the scratch hardness of the sliding layer. TABLE 1 shows the results thereof.

As it is apparent from TABLE 1, both of the Examples 1-1 and 1-2 include the first and second polyimide precursors, and show scratch hardnesses higher than those of A, D, E, and J which are formed of only one of the polyimide precursors. When the samples are compared within the equal baking temperature conditions (A, B, C, Example 1-1, Example 1-2, and D), it is found that the scratch hardness is maximized in a range where the mixture ratios of the first and second polyimide precursors is 1:9 to 4:6 as a whole.

When the samples having the equal mass mixture ratio between the first and second polyimide precursors but baked at different temperatures, i.e., 250° C. and 300° C., (A and E, B and F, C and G, Example 1-1 and H, Example 1-2 and I, and D and J) are compared, it is found that the samples baked at the higher temperature have a higher scratch hardness. This is considered to be caused by the fact that the imidization ratio of the second polyimide having the imidization ratio around 70% to 93% is increased, and, consequently, the wear resistance is increased by increasing the baking temperature.

### [Idling Acceleration Endurance Test]

The fixing belts of the above-mentioned respective samples were mounted on the fixing apparatus as shown in FIG. 1, and an idling endurance test was carried out by using the fixing apparatus in the following manner. Firstly, while controlling the heater temperature of the fixing apparatus to 240° C., the pressure roller was pressed onto the fixing belt with a predetermined pressing force to rotate the fixing belt following the pressure roller. The pressure roller of φ30 mm in diameter and in which a PFA tube of 40 μm was covered over an elastic layer made of silicone rubber and having a thickness of 3 mm was used. In the idling endurance test, the pressing force was 313 N, and a nip portion had dimensions of 8 mm in width×310 mm in length, and the surface velocity of the fixing belt was set at 246 mm/s. In addition, in order to improve lubrication, 0.2 g of HP300 (manufactured by Dow Corning Corporation) was applied as a lubricant on the surface of the sliding layer of the ceramic heater 43 in the test.

The amount of the lubricant applied in this test condition is far smaller than that of the normal product specification and the temperature controlled temperature is also higher than that of the product specification. That is, a severe test condition in which the lubricant tends to be easily gasified and depleted and the stick-slip tends to more easily occur was adopted. In the idling endurance test, the time period until when an unusual noise (judder) caused by the stick-slip occurs was measured and set as the endurance time period.

A correlation between the idling acceleration endurance test and the sheet feeding endurance test carried out by using the actual machine was reviewed. It was then found that a sample that does not cause the stick-slip even after 400 minutes or more in the idling acceleration endurance test has the endurance that enables to feed a cumulative number of 300,000 sheets or more in the sheet feeding endurance test in the actual machine. Therefore, 300,000 sheets in the cumulative feed number of sheets was set as the set lifetime of the fixing belt, and for the samples which exceed 400 minutes in the idling acceleration endurance test, the test was terminated after exceeding 400 minutes. TABLE 1 shows the results.

As it is apparent from TABLE 1, the higher the mixture ratio of the second polyimide precursor, the more the stick-slip was suppressed from occurring. Still further, for the samples having the polyimide resin layers in which the mass mixture ratio of (second polyimide precursor)/(first polyimide precursor+second polyimide precursor) is 0.6 or greater under the condition in which the baking temperature is 250° C., the endurance time period of all the samples exceeded 400 minutes. Therefore, in view of the suppression of the stick-slip, the mass mixture ratio of (second polyimide precursor)/(first polyimide precursor+second polyimide precursor) is desirable to be greater than or equal to 0.6 (≧0.6).

The samples having the same mass mixture ratio between the first and second polyimide precursors but baked at different temperatures, i.e., 250° C. and 300° C., (A and E, B and F, C and G, Example 1-1 and H, Example 1-2 and I, and D and J) are compared. It is then found that the stick-slip tends to occur in the samples baked at the higher baking temperature. This is considered to be caused by the drop of the loss elastic modulus by increasing the baking temperature.

### [Actual Machine Sheet Feeding Endurance Test]

Further, as another endurance test, the fixing apparatus as shown in FIG. 1 was mounted on a full-color LBP (LBP-5900; manufactured by Canon Inc.), and images were consecutively formed on 300,000 sheets, to execute an endurance test in terms of a feed number of sheets. The pressing force was set at 250 N, the nip section had dimensions of 8 mm×310 mm, the fixing temperature was set at 190° C., and the process speed was set at 180 mm/sec. In order to improve lubrication between the sliding layer of the fixing belt and the ceramic heater, 1.5 g of HP300 (manufactured by Dow Corning Corporation) was applied on the surface of the ceramic heater as a lubricant for the test. TABLE 1 shows the results. It is noted that the alphabet “k” shown after a numeral in TABLE 1 denotes “×1000”. For example, a feed number of sheets of “50 k” denotes “50×1000”, i.e., 50,000 sheets.

As it is apparent from TABLE 1, the fixing apparatus using the fixing belts of the Example 1-1 and Example 1-2 passed the endurance test of 300,000 sheets without any trouble. However, the fixing apparatus using the fixing belts of A, B, C, E, F, G, and H, generate, an unusual noise (judder) due to stick-slip, and the endurance test was terminated in the middle of the test. This is considered to be caused by the fact that, because the mass mixture ratio of the first polyimide precursor is high, the loss elastic modulus is reduced.

The baking temperature of the samples E, F, G, and H is 300° C. and their loss elastic modulus is reduced as compared to that of the samples baked at 250° C. under the same condition (that is, A, B, C, and Example 1-1), so that the lifetime of the fixing belt with regard to the stick-slip is shortened. With regard to the sample D, the test is an endurance test of a fixing belt in which the sliding layer is formed of only the second polyimide precursor. With regard this, the base member was exposed due to an inner surfacial scrape in a stage of 220,000 sheets, and it was confirmed finally that a slip had occurred and a defective image had been formed.

The samples I and J caused a crack of the base member in a stage of 250,000 sheets, and the endurance test was terminated at that point. This is considered to be caused by the fact that because the baking temperature in forming the film was as high as 300° C., the fatigue strength of the base member formed of nickel-iron alloy was reduced.

As described above, it was found that the present invention enables to attain both the wear resistance and the stick-slip suppressing effect. It was also found that the sliding layer more effective in terms of attaining both the wear resistance and the stick-slip suppressing effect can be formed and the lifetime can be prolonged by mixing the first and second polyimide precursors such that their mass mixture ratio is in the range of 1:9 to 4:6.

### Second Example

In a second example, molybdenum disulfide LM-11 (manufactured by Daitou Co., Ltd.) was mixed as an inorganic filler into the polyimide precursor solution of the first example, and tests were carried out with similar evaluation items. TABLE 1 shows samples of the fixing belts having the sliding layers thus formed. In the second example, evaluations of wear resistance and various endurance tests similar to those of the first example were carried out on Example 2-1, Example 2-2, and samples K-N. TABLE 1 shows the results.

Samples having the equal mass mixture ratio between the first and second polyimide precursors, but are different in terms of what is mixed with molybdenum disulfide and what is not mixed are compared (A and K, B and L, C and M, Example 1-1 and Example 2-1, Example 1-2 and Example 2-2, and D and N). It was found that the samples mixed with molybdenum disulfide mixed have a tendency of having a stronger scratch hardness. This is because molybdenum disulfide fallen out of the polyimide resin layer acts as a solid lubricant and suppresses wear of the polyimide resin layer.

In the idling acceleration endurance test and the actual machine sheet feeding endurance test, the samples mixed with molybdenum disulfide have a tendency of suppressing the occurrence of the stick-slip. This is considered to be caused by the facts that because the surface of the polyimide resin layer is roughened and the contact area between the polyimide resin layer and the ceramic heater is reduced by mixing molybdenum disulfide, and because the molybdenum disulfide fallen out of the polyimide resin layer acts as a solid lubricant.

As described above, it was found that mixing an inorganic filler in the polyimide resin is effective in improving the wear resistance and suppressing the stick-slip.

### Third Example

In a third example, tests were carried out with similar evaluation items after forming the fixing belt in the same manner with the first example and regulating the surface roughness (ten-point average roughness Rz) of the sliding layer by a roughening process. TABLE 1 shows samples of the fixing belts having the sliding layers thus formed. In the third example, evaluations of the wear resistance and various endurance tests were carried out in the same manner with the first example on Example 3-1, Example 3-2, and samples O-R shown in TABLE 1. The results are shown in TABLE 1.

Sampless having the equal mass mixture ratio between the first and second polyimide precursors and are different in terms of Rz of the surface of the sliding layer, i.e., near 1.0 μm and near 4.5 μm, are compared (A and O, B and P, C and Q, Example 1-1 and Example 3-1, Example 1-2 and Example 3-2, and D and R). It was found that, although no change is seen in the scratch hardness caused by the roughness in the evaluation of the wear resistance, the samples with the ten-point average roughness of around 4.5 μm have a tendency of suppressing the occurrence of the stick-slip in the idling acceleration endurance test and the actual machine sheet feeding endurance test. This is considered to be caused by the facts that the contact area between the polyimide resin layer on the inner circumferential surface of the fixing belt and the ceramic heater is reduced by the roughening process and that the applied lubricant tends to stay in the recesses produced by the roughening process.

As described above, it was found that the roughening process of the polyimide layer is effective in suppressing the stick-slip. In addition, an inventor et al. of the present invention have found that the ten-point average roughness of the polyimide resin layer of about 2.5 μm to 6.5 μm is optimal as a standard in performing the roughening process, and the advantageous effect of the roughening process is not obtained when the ten-point average roughness is out of this range.

### Other Embodiments

In the embodiment described above, the case in which the present invention is applied to the fixing apparatus using the ceramic heater has been described. However, the present invention is applicable to any heater other than the ceramic heater (that is, heaters made of other materials) so long as the inner circumferential surface of the belt is configured to slide in the use condition. The present invention is applicable also to a fixing apparatus which employs an IH system for the heating system or to a heating belt (including a film) used in such a fixing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-228823, filed on Oct. 16, 2012 which is hereby incorporated by reference herein in its entirety.

What is claimed is:

1. An endless heating belt for heating an image on a recording medium, the heating belt comprising:
a base member made of a metal or a heat-resistant resin; and
a sliding layer formed on an inner surface of the base member and sliding against a slide member, the sliding layer being a polyimide resin layer formed by mixing a first polyimide precursor and a second polyimide precursor whose loss elastic modulus is greater than that of the first polyimide precursor and by baking a mixture of the first and second polyimide precursors at a predetermined baking temperature.

2. The heating belt according to claim 1, wherein the first polyimide precursor has an imidization ratio at the predetermined baking temperature of 95% to 100%, and
wherein the second polyimide precursor has an imidization ratio at the predetermined baking temperature of 70% to 93%.

3. The heating belt according to claim 1, wherein a mass mixture ratio between the first polyimide precursor and the second polyimide precursor is in a range such that (the first polyimide precursor):(the second polyimide precursor)=1:9 to 4:6.

4. The heating belt according to claim 2, wherein a mass mixture ratio between the first polyimide precursor and the second polyimide precursor is in a range such that (the first polyimide precursor):(the second polyimide precursor)=1:9 to 4:6.

5. The heating belt according to claim 1, wherein a polyimide obtained by baking the second polyimide precursor at the predetermined baking temperature has a glass transition point approximately equal to a predetermined temperature to which the heating belt is heated, and
wherein a polyimide obtained by baking the first polyimide precursor at the predetermined baking temperature has a higher glass transition point than the polyimide obtained by baking the second polyimide precursor.

6. The heating belt according to claim 2, wherein a polyimide obtained by baking the second polyimide precursor at the predetermined baking temperature has a glass transition point approximately equal to a predetermined temperature up to which the heating belt is heated, and
wherein a polyimide obtained by baking the first polyimide precursor at the predetermined baking temperature has a higher glass transition point than the polyimide obtained by baking the second polyimide precursor at the predetermined baking temperature.

7. The heating belt according to claim 4, wherein a polyimide obtained by baking the second polyimide precursor at the predetermined baking temperature has a glass transition point approximately equal to a predetermined temperature up to which the heating belt is heated, and
wherein a polyimide obtained by baking the first polyimide precursor at the predetermined baking temperature has a higher glass transition point than the polyimide obtained by baking the second polyimide precursor.

8. The heating belt according to claim 1, wherein the polyimide resin layer contains an inorganic filler.

9. The heating belt according to claim 7, wherein the polyimide resin layer contains an inorganic filler.

10. The heating belt according to claim 1, wherein the sliding layer has a ten-point average roughness of a surface of 2.5 μm to 6.5 μm, and
wherein a lubricant is applied on the surface of the sliding layer.

11. The heating belt according to claim 9, wherein the sliding layer has a ten-point average roughness of a surface of 2.5 μm to 6.5 μm, and
wherein a lubricant is applied on the surface of the sliding layer.

12. The heating belt according to claim 1, wherein each of the first polyimide precursor and the second polyimide precursor is an aromatic polyimide precursor.

13. The heating belt according to claim 11, wherein each of the first polyimide precursor and the second polyimide precursor is an aromatic polyimide precursor.

14. An endless heating belt for heating an image on a recording medium, the heating belt comprising:
a base member having a metal or a heat-resistant resin; and
a sliding layer formed on an inner surface of the base member and sliding against a slide member, the sliding layer being a polyimide resin layer formed by mixing a first polyimide precursor having an imidization ratio at a predetermined baking temperature of 95% to 100%, and a second polyimide precursor having an imidization ratio at the predetermined baking temperature of 70% to 93%.

15. The heating belt according to claim 14, wherein a mass mixture ratio between the first polyimide precursor and the second polyimide precursor is in a range such that (the first polyimide precursor):(the second polyimide precursor)=1:9 to 4:6.

16. The heating belt according to claim 14, wherein a polyimide obtained by baking the second polyimide precursor at the predetermined baking temperature has a glass transition point approximately equal to a predetermined temperature to which the heating belt is heated, and
wherein a polyimide obtained by baking the first polyimide precursor at the predetermined baking temperature has a higher glass transition point than the polyimide obtained by baking the second polyimide precursor.

17. The heating belt according to claim 14, wherein the polyimide resin layer contains an inorganic filler.

18. The heating belt according to claim 14, wherein the sliding layer has a ten-point average roughness of a surface of 2.5 μm to 6.5 μm, and
wherein a lubricant is applied on the surface of the sliding layer.

19. A heating apparatus comprising:
the heating belt according to claim 1;
a slide member sliding against an inner surface of the heating belt; and
a nip portion forming member which forms a nip portion between the nip portion forming member and the heating belt, the nip portion heating a recording medium passing through the nip portion.

20. The heating apparatus according to claim 19, wherein the slide member is a ceramic heater which heats the heating belt.
